(19) United States
(12) Patent Application Publication
(10) Pub. No.: US 2006/0195357 A1
(43) Pub. Date: Aug. 31, 2006

(54) Providing and communicating synergies between absorbent articles and disposable wipes

(76) Inventors: Thomas James Klofta, Cincinnati, OH (US); Philip Andrew Sawin, Hamilton, OH (US); Paul Thomas Weisman, Cincinnati, OH (US); John Collins Dyer, Cincinnati, OH (US); Mark James Kline, Okeana, OH (US)

Correspondence Address: THE PROCTER & GAMBLE COMPANY;INTELLECTUAL PROPERTY DIVISION, WINTON HILL BUSINESS CENTER - BOX 161, 6110 CENTER HILL AVENUE, CINCINNATI, OH, 45224, US

(21) Appl. No.: 11/066,643

(22) Filed: Feb. 25, 2005

(51) Int. Cl. G06Q 30/00

(52) U.S. Cl. 705/14

(57) ABSTRACT

A method and system for communicating a synergy between at least one absorbent articles product and at least one wipes product. Said method and system capable of directing a consumer to select a particular combination of absorbent articles product and wipes product. Said method and system including at least one absorbent articles product and at least one wipes product, wherein said at least one wipes product having a synergistic effect with said at least one absorbent articles product. Said method and system also including a communication for directing a consumer to select a particular combination of said at least one absorbent articles product and said at least one wipes product so as to benefit from said synergistic effect.

### FIELD OF THE INVENTION

This invention relates to a method and product line-up for providing and communicating synergies between absorbent articles and disposable wipes. More specifically, this invention relates to a method and product line-up for providing and communicating synergies between absorbent articles and disposable wipes such that a consumer can select the proper combination of absorbent articles and wipes for a particular need.

### BACKGROUND OF THE INVENTION

Absorbent articles, such as disposable diapers, are well known. Wipes, such as disposable baby wipes, are also well-known. Further, providing a variety of product versions of both absorbent articles and wipes on a store shelf is also well known. For instance, a variety of absorbent articles may be sold having variations in absorbency levels, perfume types, lotion types, wear properties, etc. Similarly, a variety of wipes may be sold having variations such as perfume types and lotion types, etc.

Unbeknownst to many consumers, however, is the technical fact that certain absorbent articles and wipes may have positive synergistic effects if the proper combination is selected. Further, the specific attributes of the absorbent article and the wipe can be tailored so as to provide specific effects if the proper combination is selected. Similarly, certain absorbent articles and wipes may have negative or nullifying effects if an improper combination is selected. Unfortunately, while the vast number of available absorbent article-and-wipe combinations provides the consumer with more options (e.g., multiple brands, multiple product versions), selecting the proper absorbent article-wipe combination is often more difficult. Furthermore, the lack of affirmative product recommendations to achieve the proper absorbent article-and-wipe combination also decreases the odds of proper synergistic effects being realized. Merely communicating that an absorbent article and a wipe have similar characteristics (e.g., both “unscented”) or have related individual product benefits (e.g., absorbent article marked for “rash guard” and a wipe marked for “sensitive skin”) does not sufficiently articulate and communicate the importance of proper synergies or the possibility of nullifying effects. This problem is further exacerbated by the growing popularity of the use of disposable absorbent articles and disposable wipes, particularly in the arena of child-care, and by the variety of product options in the absorbent article and wipes areas that offer an increasing number of benefit-areas. Specifically, the previously noted examples of “Rash Guard” Diapers and “Sensitive” Wipes or “Newborn” Wipes are all examples of products that state a specific benefit or are noted as being intended for a specific usage situation.

These product descriptors are incomplete, however, in that they do not fully describe to the consumer, the possibilities of improved and/or altered levels of performance that can arise from the use of the individual absorbent article or wipe with a corresponding wipe or absorbent article, respectively.

In a first example of a positive synergy, a newborn having particular skin sensitivities may first be properly cleansed with a wipe having a mild emulsifier cleansing system and a higher pH buffer system. The mild emulsifier cleansing system adequately cleans without significantly removing previously-applied lotion (via transfer from the diaper's topsheet) from the newborn's skin, thus providing continued skin benefits. The higher pH buffer system synergistically enhances the skin health ingredients which are present in the diaper lotion. Next, an absorbent article containing a lotion having skin health ingredients may be applied for further skin benefits, particularly in the presence of said pH buffer. While this example is the preferred instance, it is not always repeated because of lack of affirmative product recommendations; consequently, the following examples are also often incurred.

In a second example of a nullifying synergy, the same newborn may be cleansed with a wipe having a stronger emulsifier cleansing system and a lower pH buffer system (or no buffer at all). In this particular example, the stronger emulsifier cleansing system may provide superior cleansing but would also remove some of the beneficial lotion that would have been transferred to the skin from the diaper. The lower pH buffer system may not enhance the skin health ingredients which are present in the lotion, in fact, much of said skin health ingredients would have been removed by the initial cleansing. Next, the same absorbent article may be applied; however, with the removal of some of the lotion and the absence of the necessary buffer system, the benefits of the same absorbent article may not be fully realized. In this particular example, the consumer may incorrectly blame the absorbent article for not performing well, where the failing actually resulted from the use of the two products in combination. Consequently, the consumer may discontinue purchasing said absorbent article, or even the entire brand of products. This example is very likely to occur as it merely requires the use of an inappropriate combination of products. Having possession of said inappropriate combination of products is likely to occur without affirmative product recommendations at the point of sale, especially in light of concurrent sales or coupons.

In a third example, the same newborn may be cleansed with the original wipe having a mild emulsifier cleansing system and a higher pH buffer system. In this particular example, the mild emulsifier cleansing system adequately cleans without significantly removing previously-applied diaper lotion from the newborn's skin, thus providing continued skin benefits. The higher pH buffer system synergistically enhances the skin health ingredients which are present in the diaper lotion and transfer to the skin upon usage. Next, an absorbent article containing a perfume and no lotion may be improperly applied, such that, the perfume may cause a skin rash to the sensitive skin and the absence of lotion results in a lack of much needed skin conditioning. In this particular example, the consumer may incorrectly blame the wipe for not performing well; consequently, the consumer may, again, discontinue purchasing said wipe, or even the entire brand of products. This example is very likely to occur as it merely requires the use of a different absorbent article product. Having possession of said different absorbent article product is likely to occur without affirmative product recommendations at the point of sale, especially in light of concurrent sales or coupons.

What is needed is a method and product line-up for communicating and creating positive, intentional synergies between absorbent articles and wipes such that a tailored regimen may be prescribed to achieve consistent synergistic performance.

### SUMMARY OF THE INVENTION

A method for communicating a synergy between at least one absorbent articles product and at least one wipes product. This method is capable of directing a consumer to select a particular combination of an absorbent articles product and a wipes product. This method may include at least one absorbent articles product and at least one wipes product which have a synergistic effect. This method may also include a communication for directing a consumer to select a particular combination of absorbent articles product and wipes product so as to benefit from their synergistic effect. This method may also include the steps of acquiring information from the consumer and basing the communication on such information. This method may also include the step of providing a related marketing capability (e.g., coupon) within the communication.

A product line-up for providing at least one intentional, repeatable synergy between at least one absorbent articles product and at least one wipes product. The product line-up is capable of directing a consumer to select a particular combination of absorbent articles product and wipes product. The product line-up may include at least one absorbent articles product and at least one wipes product which have a synergistic effect. The product line-up may include a communication for directing a consumer to select a particular combination of an absorbent articles product and a wipes product so as to benefit from their synergistic effect. The communication may provide information to the consumer such that the consumer may rely on this information in order to select the proper combination of absorbent articles product and wipes product for a given need. The product line-up may have a user interface which is capable of presenting at least one question to the consumer in order to make a communication to the consumer as to the proper combination of absorbent articles product and wipes product for a given need. The product line-up may also include at least one related marketing capability (e.g. coupon) within the communication. The product line-up may have a first absorbent articles product and a second absorbent articles product. The first absorbent articles product may have at least one characteristic being different from that of the second absorbent articles product. The differing characteristic may be selected from the group consisting of presence of a perfume, level of a perfume, type of a perfume, absorbency level, size, fit, color, gender-based features, presence of a skin health ingredient, level of a skin health ingredient, type of a skin health ingredient, presence of a film former, level of a film former, type of a film former, presence of a cleaning agent, level of a cleaning agent, type of a cleaning agent, emulsifiers, emollients, viscosity controlling agents, sequestrants, solubilizers, preservatives, antifoaming agents, antimicrobial agents, antioxidants, reducing agents, oxidizing agents, biological additives, pH adjusters and buffering agents, colorants, cosmetic astringents, cosmetic biocides, film formers, fragrance components, humectants, opacity agents, skin conditioning agents, skin protectants, solvents, sunscreen agents, botanical ingredients, absorbents, astringents, emulsion stabilizers, suspending agents, foam boosters, hydrotropes, and ultraviolet light absorbers.

The communication of the synergistic effect may be based upon the skin type of a wearer. The communication of the synergistic effect may be based upon the age of a wearer. The communication may be presented in a form selected from the group consisting of posters, pamphlets, coupons, kiosk, personal greeters, internet website, computer system and any other suitable communication devices. The product line-up may include a plurality of absorbent articles products, wherein said plurality absorbent articles products may be displayed and sorted by a corresponding grouping within a baby stages of development marketing model.

### BRIEF DESCRIPTION OF THE DRAWINGS

While the specification concludes with claims particularly pointing out and distinctly claiming the subject matter that is regarded as the present invention, it is believed that the invention will be more fully understood from the following description taken in conjunction with the accompanying drawings. None of the drawings are necessarily to scale.

FIG. 1 is a schematic view of an exemplary display of absorbent articles products and wipes products along with a communication for directing a consumer to a particular synergy;

FIG. 2 is a schematic view of another exemplary display of absorbent articles products and wipes products;

FIG. 3a is a schematic view of the display from FIG. 2 along with a user interface for asking questions of a consumer; and

FIG. 3b is a schematic view of the display from FIG. 3a along with a user interface providing a communication for directing a consumer to a particular synergy.

### DETAILED DESCRIPTION OF THE INVENTION

Definitions:

The term “absorbent article” herein refers to devices which absorb and contain body exudates and, more specifically, refers to devices which are placed against or in proximity to the body of the wearer to absorb and contain the various exudates discharged from the body, such as: incontinence briefs, incontinence undergarments, absorbent inserts, diaper holders and liners, feminine hygiene garments and the like. Said absorbent article may have an absorbent core having a garment surface and a body surface; a liquid permeable topsheet positioned adjacent to said body surface of said absorbent core; and a liquid impermeable backsheet positioned adjacent to said garment surface of said absorbent core.

The term “disposable” is used herein to describe absorbent articles which generally are not intended to be laundered or otherwise restored or reused as absorbent articles (i.e., they are intended to be discarded after a single use and, preferably, to be recycled, composted or otherwise discarded in an environmentally compatible manner).

The term “diaper” herein refers to an absorbent article generally worn by infants and incontinent persons about the lower torso.

The term “pant”, as used herein, refers to disposable garments having a waist opening and leg openings designed for infant or adult wearers. A pant may be placed in position on the wearer by inserting the wearer's legs into the leg openings and sliding the pant into position about the wearer's lower torso. A pant may be preformed by any suitable technique including, but not limited to, joining together portions of the article using refastenable and/or non-refastenable bonds (e.g., seam, weld, adhesive, cohesive bond, fastener, etc.). A pant may be preformed anywhere along the circumference of the article (e.g., side fastened, front waist fastened). While the term “pant” is used herein, pants are also commonly referred to as “closed diapers”, “prefastened diapers”, “pull-on diapers”, “training pants” and “diaper-pants.” Suitable pants are disclosed in U.S. Pat. No. 5,246,433, issued to Hasse, et al. on Sep. 21, 1993; U.S. Pat. No. 5,569,234, issued to Buell et al. on Oct. 29, 1996; U.S. Pat. No. 6,120,487, issued to Ashton on Sep. 19, 2000; U.S. Pat. No. 6,120,489, issued to Johnson et al. on Sep. 19, 2000; U.S. Pat. No. 4,940,464, issued to Van Gompel et al. on Jul. 10, 1990; U.S. Pat. No. 5,092,861, issued to Nomura et al. on Mar. 3, 1992; U.S. patent application Ser. No. 10/171,249, entitled “Highly Flexible And Low Deformation Fastening Device”, filed on Jun. 13, 2002; U.S. Pat. No. 5,897,545, issued to Kline et al. on Apr. 27, 1999; U.S. Pat. No. 5,957,908, issued to Kline et al on Sep. 28, 1999.

The term “machine direction (MD)” or “longitudinal” herein refers to a direction running parallel to the maximum linear dimension of the article and/or fastening material and includes directions within ±45° of the longitudinal direction.

The term “cross direction (CD)”, “lateral” or “transverse” herein refers to a direction which is orthogonal to the longitudinal direction and includes directions within ±45° of the lateral or transverse direction.

The term “joined” encompasses configurations whereby an element is directly secured to another element by affixing the element directly to the other element, and configurations whereby an element is indirectly secured to another element by affixing the element to intermediate member(s) which in turn are affixed to the other element.

The term “synergy” herein refers to the interaction of two or more items such that their total effect is greater than the sum of their individual effects.

The term “product line-up” herein refers to an array of two or more different products being displayed along with a communication for communicating synergies between said products.

The terms “babies” (“baby” in singular) is intended to describe persons ranging in age from newborn to about 2-7 years old. Young children often referred to variously as toddlers, pre-school aged children, or even school aged children all come within this definition. It is specially contemplated that the definition of babies as used herein will encompass children of an age who can talk and have greater dexterity, motor skills and the like than younger babies (for example, as compared to newborn babies). Such older babies (as the term is used herein) may be able to use baby wet wipes products themselves while younger babies may need a caregiver to use the product on them. There is no single upper age limit for babies (as that term is used herein) and it will be recognized that babies progress through stages of development at differing rates. The characteristics of the stages and situations (described in greater detail below) may be more significant than the typical age ranges associated with such stages and situations. Age ranges are by necessity averages and generalities. The ability of the line ups of the present invention to target on the basis of situation and stage (as determined without strict reference to age) is one of its benefits. While no particular upper age limit exists for babies, it is typical that those making the ultimate purchase decision with respect to particular products in the line up will not be a baby within the meaning defined above. In other words, even though older babies may be involved in the use and purchase of baby wipes for their stage or use situation, they often will not make the entire purchase decision on their own (as an example, a 5 year old might tell his or her parent what product he or she desires, but ultimately the parent makes the decision to purchase or not).

Description:

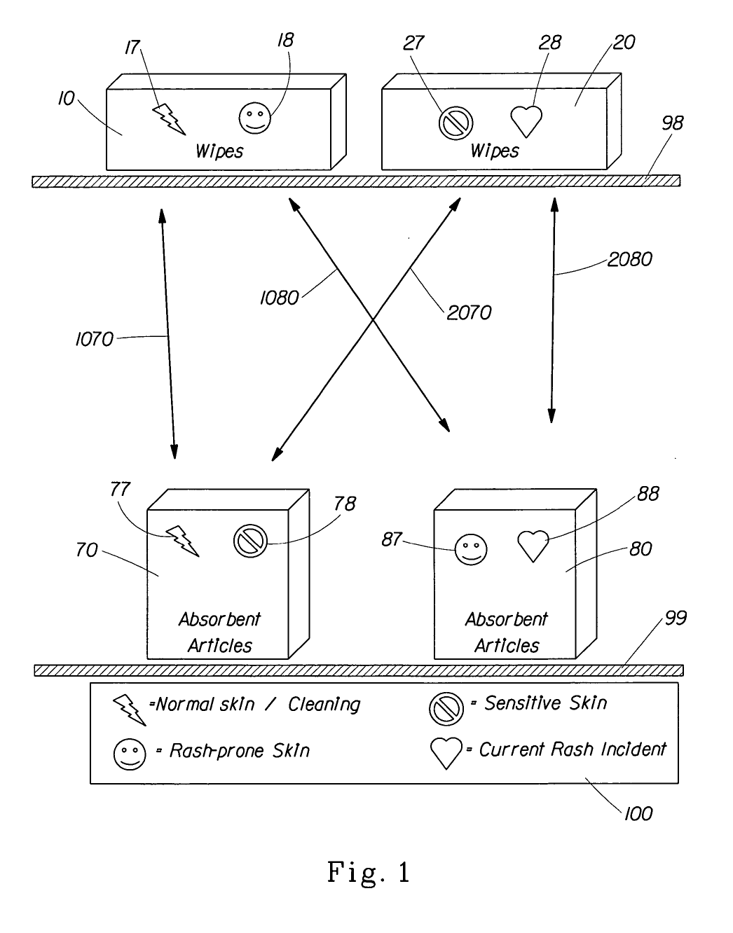

FIG. 1 shows a first, non-limiting, exemplary embodiment of the present invention. More specifically, this particular example depicts a first wipes product 10 and a second wipes product 20 being displayed on a first shelf 98. Further, this example depicts a first absorbent article product 70 and a second absorbent article product 80 being displayed on a second shelf 99. One skilled in the art would appreciate that said products may be located in the same or different location (e.g., same or different shelf) although one may prefer that all products were located as closely to one another as possible. As presented in this particular example, a consumer is presented with at least four wipes-and-absorbent-article combinations; namely, a first combination 1070 consisting of wipes 10 and absorbent articles 70; a second combination 1080 consisting of wipes 10 and absorbent articles 80; a third combination 2070 consisting of wipes 20 and absorbent articles 70 and a fourth combination 2080 consisting of wipes 20 and absorbent articles 80. Each of the wipes-and-absorbent-article combinations may or may not have a different synergistic effect specific to a particular consumer situational need. Some of said synergies may provide optimal synergistic benefits while other synergies may not. And while conventional store shelves already contain a plurality of wipes and absorbent articles, the present invention is novel in that it provides a communication to the consumer as to the situational need(s) addressed by the corresponding synergistic effect such that the consumer is informed of said effect and properly instructed as to which products to buy so as to repeatedly achieve the desired synergistic benefit and to be able to repeatedly and correctly choose a different set of products as those situational needs change.

For example, in one exemplary embodiment, a display of various disposable absorbent articles and various disposable wipes may be provided along with communication capable of directing the consumer to a pair of products to meet their situational needs based on the synergistic skin benefits. In providing such skin-related synergies, a variety of compositions may be used. For instance, first wipe product 10 may contain disposable wipes having a lotion composition which is aqueous in nature. Further, said lotion may contain active materials, preferably no more than 10% by weight. Further, said lotion may contain other ingredients including, but not limited to, emulsifiers, emollients, viscosity agents, sequestrants, solubilizers, and preservatives. Other ingredients that one might consider adding to the composition include antifoaming agents, antimicrobial agents, antioxidants, reducing agents, biological additives, pH adjusters and buffering agents, colorants, cosmetic astringents, cosmetic biocides, film formers, fragrance components, humectants, opacity agents, skin conditioning agents, skin protectants, solvents, sunscreen agents, hydrotropes, and ultraviolet light absorbers. First wipe product 10 may have an emulsifier system designed to provide superior cleaning as compared to an emulsifier system in said second wipe product 20. Said emulsifier system in 20 may include, but is not limited to, a mild amphoteric (e.g., cocamidopropyl betaine) and a non-ionic emulsifier. Such an exemplary mixture of amphoteric and non-ionic emulsifier should be mild to the skin of the wearer. Further, particularly for first wipe product 10, the cocamidopropyl betaine may be combined with a non-ionic emulsifier (e.g., polyoxyethylene 20 sorbitan monooleate) to make a skin-mild and effective cleaning system. And while anionic emulsifiers are generally more irritating to the skin, they are typically more effective cleaners than the non-ionic and amphoteric emulsifiers. Interestingly, combinations of anionic emulsifiers with amphoteric betaines have been employed in baby shampoos due to their mildness and effective cleaning performance. Combinations of sodium lauryl sulfate with betaines of the imidazolinium or alkyl amido type have been effective in being both mild to the skin while providing effective cleaning action. Thus, another exemplary cleaning system for first wipe product 10 may include sodium lauryl sulfate and 3-cocoamidopropyldimethyl betaine, such an emulsifier system would be mild to the skin while still providing effective cleaning.

In still referring to first wipes product 10, said product may include a stimulating perfume to accentuate its superior cleaning performance. Exemplary stimulating perfumes include, but are not limited to, citrus-scented perfumes (e.g., linalyl propionate, lemonile, and tetrahydro linalyl acetate; all available from Givaudan located in Paris, France).

In addition, first wipes product 10 may include a pH buffer system (e.g., designed to achieve pH of about 5.5, such as, acetic acid:sodium acetate, benzoic acid:sodium benzoate, citric acid:sodium citrate, and potassium hydrogen phthalate:sodium hydroxide) in order to match the natural pH of the skin and to activate “pro-perfumes” in diaper lotions discussed later. Pro-perfumes may include, but are not limited to, acetal-type organic compounds, ketal-type organic compounds, and orthoester-type organic compounds. Said pro-perfumes are typically stable at approximately neutral pH or in anhydrous environments, but hydrolyze and break down at acetic or basic pH's. This hydrolysis leads to bond breakage and the consequent release of the volatile perfume moiety. With a pro-perfume formulated into the anhydrous diaper lotion (discussed later), an acetic pH buffer formulated into the first wipes product 10 will transfer to the skin to enhance its buffer capacity at a pH of 5.5 or lower. With some of this pH buffer on the skin, the hydrolysis break-down reaction of the pro-perfume transferred to the skin via the diaper lotion is enhanced. Lower or higher pH buffer systems could also be used in wipes product 10 to enhance the hydrolysis breakdown of the pro-perfume in the anhydrous diaper lotion (discussed later). The pH delivered by the pH buffer may have to be optimized for effective hydrolysis of the pro-perfume while also providing for effective skin health.

Now referring to second wipes product 20, said second wipes product may contain disposable wipes having a lotion composition which is aqueous in nature. Further, said lotion may contain skin health ingredients, preferably no more than 10% by weight. Further, said lotion may contain other ingredients including, but not limited to, emulsifiers, emollients, viscosity controlling agents, sequestrants, solubilizers, and preservatives. Second wipe product 20 may have an emulsifier system designed to provide moderate cleaning as compared to the emulsifier system in said first wipe product 10. For instance, said second emulsifier system may be designed to insignificantly, or not at all, remove any film former transferred to the skin via the diaper lotion (discussed later). Said second emulsifier system may include, but is not limited to, amphoteric surfactants (e.g., cocamidopropyl betaine) and nonionic surfactants (e.g., polyoxyethylene sorbitan monoalkylates, ethoxylated long chain alcohols, and sorbitan monoalkylates).

Unlike the pH buffers of first wipes product 10, second wipes product 20 may not contain a pro-perfume activator. Rather, second wipes product 20 may contain a more neutral pH buffer (e.g., pH of about 7.5) in order to enhance the performance of actives found in some diaper lotions (e.g., absorbent article 80 which is discussed later) while not activating pro-perfumes found in some diaper lotions (e.g., absorbent article 70 discussed later). One skilled in the art would appreciate that other optional ingredients may be used to synergistically enhance the performance of said skin health ingredients. These optional ingredients may include, but are not limited to, cationic or anionic ions, acids, bases, reducing agents, oxidizing agents, metals, catalysts, enzymes, inorganic compounds, organometallic compounds, biological ingredients, and organic compounds. Lastly, second wipes product 20 may contain a perfume that emanates a soothing scent.

Now referring to first absorbent article product 70, said product may contain absorbent articles having a diaper lotion composition which is non-aqueous in nature. Further, said lotion may contain lipophilic ingredients (e.g., emollients, skin conditioning agents), viscosity controlling agents, perfumes, emulsifiers, optional ingredients (e.g., zinc oxide) and mixtures thereof. Another optional ingredient may be a film former which transfers to the skin from the diaper in order to protect the skin from irritants found in urine and feces. Additionally, said film former may improve the tactile feel of the wearer's skin. Additionally, said film former may modify such skin properties as surface tension and frictional forces in order to improve overall cleaning performance. Transfer of the film former to the baby's skin may occur in a variety of ways including, but not limited to, via frictional forces, melting via body heat, and release via emulsification due to contact of the emulsifier-containing diaper lotion with moisture on the skin. This moisture may arise from several sources including, but not limited to, natural moisture content of the skin, condensation of moisture from a humid environment, residual moisture deposited from a cleaning implement such as a wipe, or moisture deposited from fecal and urine exudates. Such suitable film formers include, but are not limited to, polyalkene-types (e.g., polyethylenes, polyisobutylenes, hydrogenated polyisobutenes, and polydecenes); copolymers of vinylpyrrolidone (e.g., PVP); long chain alpha olefins (e.g., Ganex V-220 and Ganex WP-660 from International Specialty Products in Wayne, N.J.); acrylic copolymers having long alkyl chains to enhance oleophilicity (e.g., acrylate/octylacrylamide copolymers such as Dermacryl 70 and LT from National Starch); olefin/isopropyl maleate/maleic anhydride copolymers (e.g., Performa V1608 from New Phase Technologies in Piscataway, N.J.; comprehensive list of film formers and other functional ingredients are listed in “CTFA Cosmetic Ingredient Handbook,” Second Edition, Edited by J. A. Wenninger and G. N. McEwen, Published by The Cosmetic, Toiletry, and Fragrance Association, 1992). Lastly, said film former may be applied as a single component or as a sub-component of the diaper composition to first absorbent article 70 in a variety of ways including, but not limited to, being applied to the diaper's topsheet using slot coaters, spray applicators or the like.

In still referring to first absorbent article product 70, said product may contain at least two perfumes. More specifically, said first absorbent article product 70 may contain a first perfume which dissolves in the anhydrous diaper lotion and is later released due to its high volatility. Said first absorbent article product 70 may also contain a second perfume which is a pro-perfume type as discussed above. Suitable pro-perfumes may include, but are not limited to, acetal (e.g., heliotropin ethylene glycol acetal), ketal (e.g., ionone dimethyl ketal), and orthoester (e.g., orthoester of triethyl orthophenylacetate) types. Said pro-perfumes may be organic in nature and neutral in charge so as to enhance their solubility in the lipophilic and anhydrous diaper lotions. As already discussed above, the pro-perfume hydrolyzes and breaks down after contact with the low pH environment as supplied by the exemplary pH 5.5 buffer system in the first wipes product 10. Such hydrolysis of the pro-perfume at low pH's (e.g., near 5.5) leads to the formation of a volatile, pleasant smelling and stimulating perfume atmosphere.

Now referring to second absorbent article product 80, said product may contain absorbent articles having a lotion composition which does not contain perfume ingredients. Optionally, said lotion may include anti-microbials useful in controlling or reducing microbial activities, and enzyme inhibitors which bind or control enzymes or proteases. Suitable anti-microbials or enzyme inhibitors include, but are not limited to, hexamidine and its salts and derivatives (e.g., hexamidine diisethionate), pentaamidine and its salts and derivatives, benzamidine and its salts and derivatives, guanadinobenzoic acid and its salts and derivatives and zinc oxide (ZnO). Additionally, the antibacterial properties of diamidine compounds, such as those in the hexamidine class, are enhanced at elevated pH levels. Thus, the hexamidine active in the diaper lotion composition of second absorbent article 80 may work most effectively within the higher pH delivered by the buffer (e.g., buffer achieving pH of 7) in second wipes product 20.

Now turning to the intentional and repeatable synergistic effects of these exemplary absorbent articles and wipes, a first synergy 1070 may result from the use of first wipes product 10 and first absorbent article product 70. Said first synergy 1070 may be specially designed for children with normal skin who rarely exhibit diaper rash or other negative skin ailments such as redness or itching. This child's skin might be described as rugged, durable, and tough. This first intentional, repeatable synergy 1070 may be marketed to a caregiver whose situational needs include the ultimate in skin cleaning performance. Said first wipes product 10 is formulated to provide superior cleaning for the effective removal of urine, fecal matter, and other contaminants on the skin. As discussed earlier, the emulsifier system of said first wipes product 10 may also contain an anionic emulsifier for effective cleaning. In some instances, it may be desirable to combine an anionic with an amphoteric emulsifier in an attempt to mitigate the potential for irritation while still providing effective cleaning.

To amplify the perception of cleaning performance of first synergy 1070, said first wipes product 10 may contain a perfume which emanates a clean, fresh scent (e.g., stemone from Givaudan, Paris, France). In addition, said first wipes product 10 may include a pro-perfume activator (e.g., in the form of an acid or base or alkaline or acidic pH buffer system) in order to activate the pro-perfume delivered to the skin via the diaper lotion of first absorbent article 70. Similarly, the pro-perfume may also emanate a clean, fresh scent. Essentially, three perfumes may be available by using the first wipes product 10 in combination with the first absorbent article product 70 (i.e., a stimulating perfume from the wipe, another stimulating and complementary pro-perfume from the diaper lotion, and an additional soothing perfume from the diaper lotion). The soothing perfume in the diaper may be overwhelmed by the two stimulating perfumes, but it is important to include for synergy 2070. A primary function of these perfumes is to translate a perception of fresh and efficient cleaning, including the benefit of efficient odor masking of feces and urine malodors. Thus, effective masking of mal-odors may occur via the use of synergy 1070.

Also in considering synergy 1070, a film former is provided via the diaper lotion composition of the first absorbent article product 70. This diaper lotion film former protects the skin from irritants and, most importantly, improves the efficient removal of irritants and contaminants from the skin. Due to the effectiveness of its emulsifier system in the first wipes product 10, the film former is substantially removed after each cleaning. As noted earlier, a primary benefit of using first wipes product 10 in combination with first absorbent article 70 is the superior cleaning made possible by the use of an efficient emulsifier cleaning system and film former which repels irritants and contaminants from contacting the skin. Such superiority is accentuated by the use of multiple perfumes which enhance the perception of cleaning and mask mal-odors, while the skin film former as transferred from the diaper eases the wiping action for the caregiver.

Referring now to a second intentional and repeatable synergy 1080 which results from the use of first wipes product 10 and second absorbent article product 80. In this example, first wipes product 10 being designed for effective cleaning is combined with second absorbent article product 80 being designed to deliver skin-health benefits via its diaper lotion composition. Such second synergy 1080 is especially desirable for use with babies having rash prone skin. By way of example, a caregiver who wants very effective cleaning of irritants from the skin and/or suspects contaminants on the skin might be causing her baby's diaper rash might select said first wipes product 10 to effectively remove these contaminants from the skin. In addition, even though there is no pro-perfume in the diaper 80 composition, the pH 5.5 activator in the first wipes product 10 may still be attractive since it is near the normal skin pH of most babies and would result in effective skin pH buffering. Note that the skin-health agent(s) in second absorbent article product 80 would still be expected to have some level of activity at the lower pH of first wipes product 10, but the degree of activity would be reduced, in line with the reduced situational need of the consumer.

With the effective cleaning provided by first wipes product 10, the use of the second absorbent article 80 having a diaper lotion composition may provide some diaper rash protection without the addition of any perfumes. Although not as effective as when combined with the second wipes product 20 (discussed later), said second absorbent article 80 would still provide some rash protection via lotion transferred to the skin. Such diaper lotion may also hinder irritants from directly contacting the skin. Such protection would be removed by the effective cleaning system in said first wipes product 10. Nonetheless, the primary desired benefits of a good cleaning wipe and an absorbent article delivering diaper lotion containing skin health ingredients are certainly delivered.

Referring now to a third intentional and repeatable synergy 2070 which results from the use of second wipes product 20 and first absorbent article product 70. In this example, the synergistic effect is designed for sensitive skin. More specifically, second wipes product 20 contains a mild emulsifier system but does not contain a significant pro-perfume activator. Absence of a pro-perfume activator in second wipe product 20 prevents the pro-perfume in first absorbent article product 70 from being activated and appreciated. Optionally, said second wipes product 20 may contain a soothing perfume; however, said soothing perfume should be selected based on its mildness to the skin.

The film former provided by the first absorbent article product 70 protects the skin from irritants and is not effectively removed by the mild emulsifier in second wipes product 20. In addition, a secondary benefit of the film former may be the reduction of the coefficient of friction in order to reduce any irritation that might be induced by the wiping action during cleaning. This could be an attractive secondary benefit; especially, for situational needs involving sensitive skin.

Referring now to a fourth intentional and repeatable synergy 2080, said synergy results from the use of second wipes product 20 and second absorbent article product 80. In the embodiment presented, this pairing of products would be intended for consumers whose situational need includes an existing incidence of rash or other source of compromised skin (e.g. versus synergy 1080 intended for caregivers whose situational need includes children with rash-prone skin). In this example, no significant perfumes are delivered via second absorbent article 80 because caregivers of children with compromised skin typically do not want perfumes. Rather, second absorbent article product 80 contains a diaper lotion having skin-health ingredients (e.g., allantoin, aluminum hydroxide, calamine, dimethicone, kaolin, zinc oxide, hexamidine). Additionally, said lotion may also contain skin protectants (e.g., petrolatum, mineral oil, silicones, and other film formers). Since no significant pro-perfume is formulated into the second absorbent article product 80, second wipes product 20 need not contain a pro-perfume activator.

Said second wipes product 20 may further be formulated to contain an emulsifier system which is designed first and foremost for mildness with good cleaning performance. In addition, this wipe emulsifier might be designed to aid in the release to the skin of the skin health ingredient and/or skin protectant as delivered from the absorbent article product 80. Additionally, second wipes product 20 may be formulated to contain an activator to enhance the activity of the skin-health ingredient in the diaper lotion composition of second absorbent article 80. For example, a pH 7 buffer may be included in said second wipes product 20 in order to enhance the performance of said skin-health ingredient (e.g., hexamidine, ZnO).

Still referring to FIG. 1, while it is important to choose the proper synergy 1070, 1080, 2070 or 2080 for a particular consumer situational need (e.g., varying skin-conditions), it is also important that said consumer's choice of the proper synergy is repeatable. To achieve repeatedly correct purchases, the present invention teaches the use various communication techniques that enable the consumer to do exactly that. For example, in this non-limiting exemplary embodiment, on-package communication (e.g., differently shaped icons, shaded icons, colored icons, animal-figure icons, numbers, letters and product monikers) may be used to provide the proper linkage for the desired synergy. Further, a display (e.g., shelf display, kiosk, etc) may also be used to provide said linkage. As shown in this example, a first lightning bolt 17 is depicted on said first wipes product 10 and a similar second lightning bolt 77 is depicted on said first absorbent article product 70. This linkage is intended to direct a consumer to purchase these two items and achieve its respective synergy 1070 which is designed for “Normal” skin. Similarly, a first smiley face 18 is also depicted on said first wipes product 10 and a similar smiley face 87 is depicted on said second absorbent article product 80. This linkage is intended to direct a consumer to purchase these two items and achieve its respective synergy 1080 which is designed for “Rash Prone” skin. Similarly, a first slashed circle 27 is depicted on said second wipes product 20 and a similar slashed circle 78 is depicted on said first absorbent article product 70. This linkage is intended to direct a consumer to purchase these two items and achieve its respective synergy 2070 which is designed for “Sensitive” skin. Similarly, a first heart 28 is depicted on said second wipes product 20 and a similar heart 88 is depicted on said second absorbent article product 80. This linkage is intended to direct a consumer to purchase these two items and achieve its respective synergy 2080 which is designed for “Current Rash Incident” skin.

In another exemplary embodiment, a shelf-display 100, or the like, may be provided to assist the consumer in recognizing the synergy most appropriate to their situational need. Non-limiting examples of shelf-displays that direct the consumer to the appropriate synergy may include, but are not limited to, posters, pamphlets, coupons, kiosk, personal greeters, internet website, computer system and any other suitable communication devices.

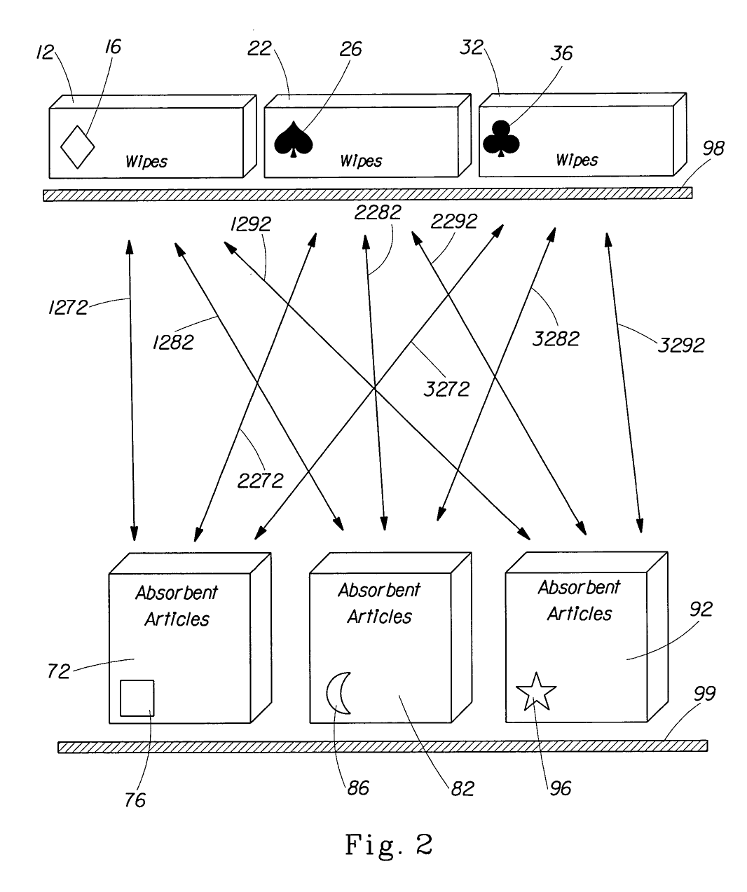

Referring now to a FIG. 2, a second, non-limiting, exemplary embodiment of the present invention is shown. More specifically, this particular example depicts a first wipes product 12, a second wipes product 22, and a third wipes product 32 being displayed on a first shelf 98. Further, this example depicts a first absorbent article product 72, a second absorbent article product 82, and a third absorbent article product 92 being displayed on a second shelf 99. One skilled in the art would appreciate that said products may be located in the same or different location (e.g., same or different shelf). As presented in this particular example, a consumer is presented with at least nine wipes-and-absorbent-article combinations; namely, a first combination 1272 consisting of wipes 12 and absorbent articles 72; a second combination 1282 consisting of wipes 12 and absorbent articles 82; a third combination 1292 consisting of wipes 12 and absorbent articles 92; a fourth combination 2272 consisting of wipes 22 and absorbent articles 72; a fifth combination 2282 consisting of wipes 22 and absorbent articles 82; a sixth combination 2292 consisting of wipes 22 and absorbent articles 92; a seventh combination 3272 consisting of wipes 32 and absorbent articles 72; an eighth combination 3282 consisting of wipes 32 and absorbent articles 82; and a ninth combination 3292 consisting of wipes 32 and absorbent articles 92. Each of the wipes-and-absorbent-article combinations may or may not have a different synergistic effect. Some of said synergies may provide optimal synergistic benefits while other synergies may not.

For example, in one exemplary embodiment, a display of various disposable absorbent articles and various disposable wipes may be provided along with communication capable of highlighting the appropriate synergy for a consumer's baby stage of development (hereinafter “BSOD”). In providing such BSOD synergies, a variety of compositions may be used. For instance, a Newborn synergy of first wipes product 12 and first absorbent article product 72 may be designed to provide specialized synergy 1272 for the situational need of babies in the age range of 0 to 9 months. For newborns, it is imperative that the wipe substrate and associated formulation be mild to the skin. Natural ingredients are often associated with mildness, thus; this synergy of products for newborns may feature the use and associated benefits of natural ingredients to provide mild cleansing, natural film formers deposited on the skin for protection against irritants, the use of naturally derived emollient oils, and natural perfumes which convey a perception of soothing mildness to the caregiver. Additionally, for first wipes product 12, it may be desirable to incorporate some level of a natural fiber; for example, the addition of cotton within the wipe substrate. Additionally, the texture and look of the substrate may also be particularly designed to convey a soft and gentle appearance while being non-abrasive to the skin. A quilted texture and look may be appropriate since many consumers associate this appearance with mildness and gentleness. An exemplary aqueous-based lotion formula for inclusion within the first wipes product 12 may be a mild emulsifier system. Said mild emulsifier system may include, but are not limited to, natural emulsifiers, lecithin, rice bran extract and phosphatidylcholine. Emulsifiers synthesized from natural ingredients may also be used. In addition to the mild cleansing as provided by the natural emulsion system, a natural emollient may be incorporated in order to provide a beneficial skin feel and possible film forming benefit. Exemplary natural emollients include, but are not limited to, almond oil, corn oil, evening primrose oil, shea butter, olive oil, borage oil, omega fish oils, jojoba bean oil, peanut oil, safflower seed oil, sesame oil, soybean oil, sunflower oil, wheat germ oil, and squalene. Lastly, naturally derived perfumes and preservatives may be utilized while still delivering against the desired synergistic effect of being mild.

Additionally, first absorbent article product 72 may have a topsheet design and texture that is similar in appearance to the wipe substrate. In this way, the softness and mildness perception of the wipe would also be reflected in the diaper. Further, the mildness perception of both products would be linked in the consumers' minds. Such linkage could also be amplified by the use of similar natural perfumes in both products. Additionally, first absorbent article product 72 may have a topsheet which is coated with an anhydrous lotion made from natural ingredients. Similar emollient oils as those mentioned above may also be employed in a base consisting of a natural wax, which would provide film forming protection on the skin. The wax may also raise the melt point of the lotion to enhance its stability on the diaper topsheet. Potential natural waxes include, but are not limited to, beeswax, carnauba wax, woolwax, candelilla wax, hemp wax, japanwax, and waxes derived from both roots and barks. After transferring to the skin, the waxes would protect the skin from irritants in the urine and feces. Lastly, first absorbent article product 72 and first wipes product 12 may contain similar optional ingredients (e.g., Vitamin E, or chamomile, or lavender, or aloe) so as to further accentuate the linkage.

In furtherance of the BSOD products offering, an infant synergy, 2282, of second wipes product 22 and second absorbent article products 82 may be designed for children in the age range of 9 to 36 months and provide synergistic benefits for infants' situational needs. Said infant synergy may include skin-health agents in combination with an efficient emulsifier cleaning system. Effective cleaning for this age group is important due to the frequency and onset of sticky and difficult to clean bowel exudates. Skin-health ingredients may also be important as the child's diet begins to include a greater variety of foods such that the opportunity for irritation may increase. Further, the surfactant system of second wipes product 22 may be similar to that of the surfactant system previously described for first wipes product 12; for example, combinations of sodium lauryl sulfate with betaines of the imidazolinium or alkyl amido type have been effective in being both mild to the skin while providing effective cleaning action. Another effective cleaning system for second wipes product 22 might include sodium lauryl sulfate and 3-cocoamidopropyldimethyl betaine. Such an emulsifier system would be mild to the skin while still providing very good cleaning. In addition, second wipes product 22 may be pH buffered to the natural ˜5.5 pH of the infant's skin. To buffer the skin at its natural pH of 5.5, the following buffer systems could be employed within the wipe: acetic acid:sodium acetate, citric acid:sodium citrate, and potassium hydrogen phthalate:sodium hydroxide, as well as other potential buffer systems. Further, second absorbent article products 82 may contain a diaper lotion that may contain an organic acid to neutralize the basic urine contaminants on the skin to maintain this natural pH of ˜5.5. Further, the skin-health ingredients that may be formulated into said second wipes product 22 may include, but are not limited to, those ingredients cited in the Skin Protectant Monograph (48 Fed. Reg. 6820, Feb. 15, 1983): allantoin, aluminum hydroxide, calamine, cocoa butter, dimethicone, glycerin, kaolin, petrolatum, shark liver oil, zinc acetate, zinc carbonate, zinc oxide and hexamidine. Hexamidine also possesses preservation properties so it could have dual performance functionality in the wipe's formulation: (1) preservation of the formulation and (2) skin health benefit properties.

As for second absorbent article product 82, said absorbent article may contain a lotion (e.g., deposited on the topsheet) that contains skin health ingredients. Similar or dissimilar skin health ingredients may be used within said wipe and said absorbent article so as to tailor a particular synergistic benefit. Certainly, it may be advantageous if the skin health ingredients in each product had amplified effects when used in combination on the skin. Additionally, said diaper lotion may contain petrolatum and/or a hardening agent such as a wax or a long chain alcohol or other effective hardening agents. The hardening agent may raise the melt point of the lotion and stabilize it on the topsheet so that it does not prematurely diffuse into the core at high storage temperatures. The diaper lotion may also be colored with an oil soluble dye to match the coloration of the wipe package or substrate. In addition, the package, topsheet, backsheet or any portion of the diaper could be printed with similar characters, patterns, colors or the like as used in the wipe to develop a linkage between the two products.

In an exemplary anhydrous diaper lotion, said lotion may include an ethoxylated alcohol emulsifier to facilitate transfer of the anhydrous system onto the skin after contact with moisture. The moisture could be derived from the skin, residual water delivered after using the wipe, or moisture from the urine or feces. This emulsification of the anhydrous lotion onto the skin may aid in the delivery of the previously mentioned film forming materials, skin protectants, or skin health ingredients. In addition, an organic acid (e.g., free acids of alkyl phosphates) may be formulated into the anhydrous lotion and be delivered to the skin to counteract the basic environment created by urine or feces on the skin. This organic acid may be used to maintain the natural pH of ˜5.5 on the skin and work synergistically with the pH buffer system from the wipe.

Lastly, the linkage of this infant synergy may be further accentuated by the use of perfume, particular tactile selections, and aesthetic features that communicate a sense of energy, discovery and vitality while also possibly communicating a skin health benefit while using said wipe. In addition, the substrate might be dyed or printed with characters to appeal to this older infant stage.

In furtherance of the BSOD products offering, a toddler synergy of third wipes product 32 and third absorbent article products 92 may be designed for children in the age range of 24 months to 7 years and provide synergy 3292. Said toddler synergy may include the use of training pants as an exemplary form of said disposable absorbent article. Further, said toddler synergy may include a high foaming surfactant system in the third wipes product 32 and friction reducing components delivered by the third absorbent article products 92. The high foaming emulsion system from said third wipes product 32 may make the cleaning experience fun for children, while the emollients as delivered from the training pant lotion make it easier for the child to put on the product by reducing friction. For example, said high foaming surfactant system may contain long chain fatty acids much like those used in high foaming shaving soaps. In another example, said high foaming surfactant system may contain sodium lauryl ether sulfate much like those used in high foaming shampoos. Additionally, the foaming action may be further enhanced by the addition of foaming agents including, but not limited to, anionic surfactants, alkanolamides, alkanolamine salts of fatty alcohol sulfates, and alkyl benzene sulfonates. Fatty alcohol sulfates provide the additional benefits of low irritation potential and creamy foam properties. Fatty alcohol ether sulfates provide the additional benefit of possessing more flash foam which may be important if the caregiver does not want to observe residual foam on the child after wiping. Additionally, sulfosuccinates may also be used as a foaming surfactant since it has a low tendency to irritate the skin or mucous membranes. Lastly, emollients, such as silicones, may be used to aid in suppressing suds on the skin to reduce their longevity after cleansing with said wipe.

Third wipes product 32 may also be formulated to include a buffer system to achieve the natural pH (about ˜5.5) of the skin. However, since the foaming of some surfactants can be influenced by pH, one skilled in the art would appreciate the need to balance the properties of buffering and foaming. Such balancing and optimization may be necessary for other performance characteristics. Additionally, third wipes product 32 may contain a perfume which communicates “fun” to the child, while being non-irritating to the skin. Additionally, said wipe may be flushable and printed with characters that appeal to the child. Finally, an optional color indicator system in said wipe may be used to highlight residual urine contaminants on the skin so that the child would have a signal to determine cleaning effectiveness.

Third absorbent article 92 may similarly be printed with characters that match the wipe and appeal to both the child and caregiver. In addition, a “fun” perfume may be incorporated in said absorbent article that is similar or complementary with the perfume in said third wipes product 32. Additionally, said third absorbent article may be a training pant which incorporates a “feel and learn” topsheet layer to enhance the potty training regiment for the child. Further, a pH ˜5.5 buffer may be applied to said “feel and learn” topsheet layer so as to match the pH buffer within said third wipe product 32 in order to enhance the skin health of the child.

Third absorbent article 92 may also include a lotion (e.g., applied on the topsheet) that delivers a skin protectant additive to the skin. Said skin protectant additive may include, but is not limited to, a silicone fluid capable of providing the following benefits: (a) protect the skin from irritants, (b) serve as a skin protectant, (c) optimize the suppression of suds on the skin, and (d) reduce friction on the skin such that the ease of putting on the training pant is enhanced. Further, silicone waxes may be added to said silicone fluid in order to stabilize the composition on the topsheet by hardening said composition. Lastly, said lotion may include additional emulsifiers, emollients, viscosity controlling agents and other cosmetic materials familiar to those skilled in the art.

One skilled in the art would appreciate that the previous descriptions of product synergies 1272, 2282, and 3292 are described as meeting the anticipated needs of caregivers as their child grows through its baby stages of development. These “vertical” synergies anticipate that the child would progress from absorbent article 72 to absorbent article 82 to absorbent article 92 simultaneously with progressing from wipe 12 to wipe 22 to wipe 32. While such a progression may be common among consumers, it is not necessarily the case, and the “cross-over” synergies (e.g. 1282, 1292, 2272, 2292, 3272, 3282) may also be needed in addressing the more complete scope of consumers' situational needs. For example, a child with sensitive or rash-prone skin who progresses from newborn stage to infant stage or toddler stage might reasonably progress from absorbent article 72 to absorbent article 82 and then to absorbent article 92, but still continue to be best served by using wipe 12 throughout this process. The caregiver for such a child would be best directed to the synergies 1282 and 1292 as the child develops. Likewise, a newborn with particularly high cleaning needs, might be best served by the synergy 2272, provided that the newborn's skin was not unduly sensitive. In yet another example, a child may progress to the use of training pants before he/she is fully ready for potty training. In this case, synergy 2292 would be most appropriate, with the child then progressing to synergy 3292 at the onset of potty training.

Similarly, “horizontal” synergies may also be appreciated; for example, a caregiver may initially use a first wipe having superior cleaning performance to clean up exudates off her baby. During this same cleaning event, the caregiver may subsequently use a second wipe having a mild lotion and/or skin health ingredient for final cleaning and deposition of a beneficial skin health ingredient to said baby's skin. In another example, horizontal synergies among absorbent articles may be appreciated. For instance, a first absorbent article having increased absorbency may be used at night, while a second absorbent article having potty training features may be used during the day. In another instance, a potentially more expensive absorbent article having skin health ingredients may be used at night, while a potentially lesser expensive absorbent article not containing skin health ingredients may be used during the day.

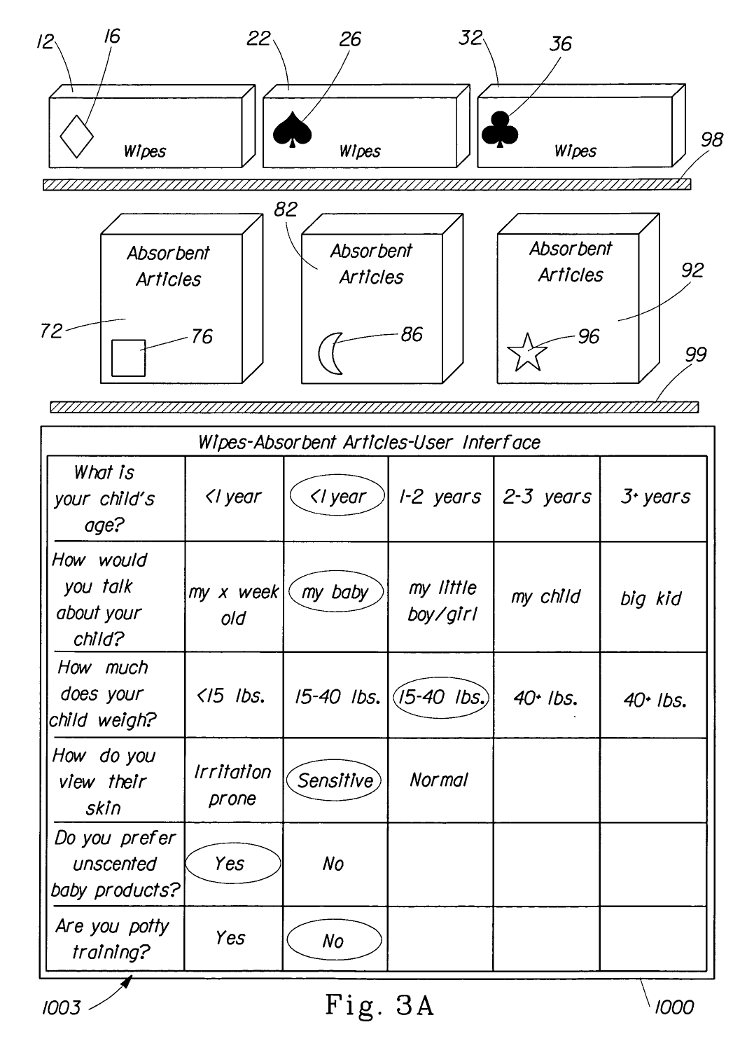

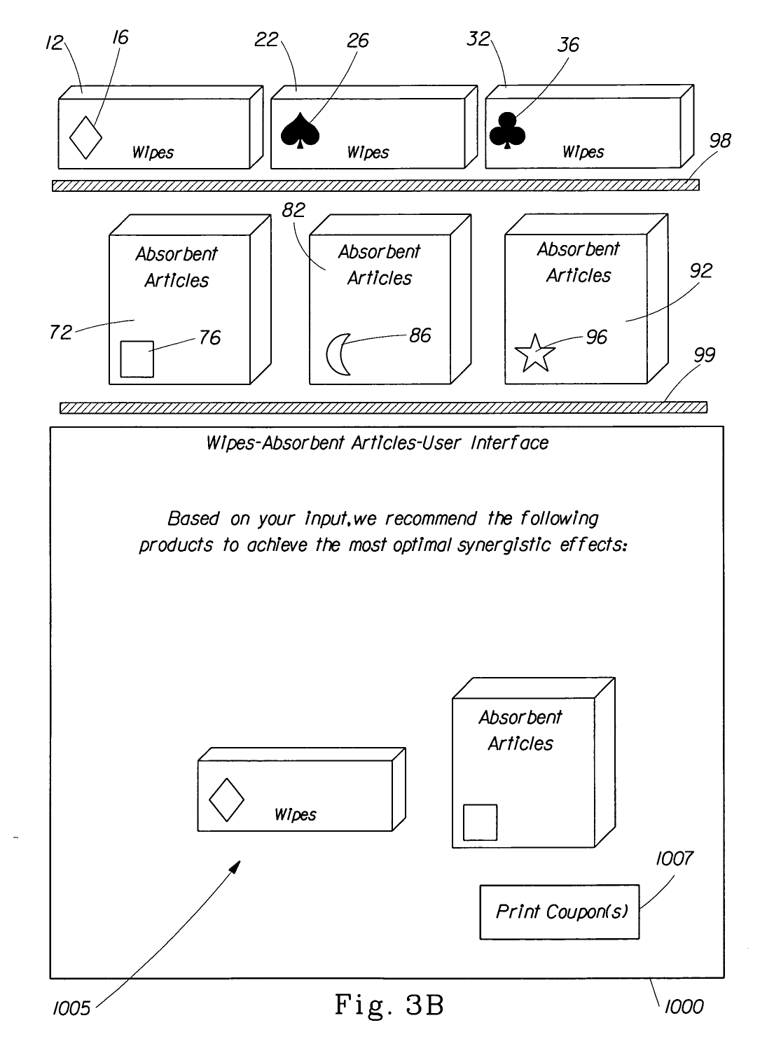

Referring now to FIGS. 3a and 3b, the products depicted in FIG. 2 having icons 16, 26, 36, 76, 86, 96 are shown along with an exemplary synergy communication. More specifically, this example depicts a computerized user interface located near the shelves 98, 99. Such an example might include a computer display on which the caregiver would answer directed questions 1003 regarding the child's stage of development. Based on the answers to these questions, the computer display would tabulate, based on predetermined criteria, the synergy best suited for the child's developmental needs, and would provide a recommendation 1005 for the appropriate wipe and absorbent article products. In this example, the computer display shows an image of said products and provides communication for finding said products on the shelves. Other related marketing features may be provided. Such features include, but are not limited to, a print-coupon button 1007.

All documents cited in the Detailed Description of the Invention are, in relevant part, incorporated herein by reference; the citation of any document is not to be construed as an admission that it is prior art with respect to the present invention.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

For example, while the described embodiments discuss the varying of the presence of skin health ingredients, perfumes, film formers, and the like, one skilled in the art would appreciate that a multitude of variations may be incorporated. For instance, a variation in absorbent article size and/or fit may be used, particularly in response to the baby's physical characteristics. In another instance, a variation in absorbency of the absorbent article may be used, particularly in response to situational needs. In yet another instance, a variation of designs in both the wipes and absorbent articles may be used, particularly in response to the child's age and/or gender.

For example, while the described embodiments discuss the use of absorbent articles products and wipes products in order to deliver baby-related synergies, one skilled in the art would recognize that other product forms and/or deliveries may be used in accordance with the present invention. One such exemplary embodiment may include the use of a first baby-related product (e.g., spray-on product, rub-on product, etc.) to deliver skin health ingredients in conjunction with a second baby-related product (e.g., wipe, absorbent article, etc.) in order to achieve a baby-related synergy. Another such exemplary embodiment may include the use of a first baby-related product (e.g., spray-on product, rub-on product, etc.) to deliver perfume benefits (e.g., odor masking, aromatherapy, etc.) in conjunction with a second baby-related product (e.g., wipe, absorbent article, etc.) in order to achieve a baby-related synergy.

What is claimed is:

1. A method for communicating a synergy between at least one absorbent articles product and at least one wipes product, said method capable of directing a consumer to select a particular combination of absorbent articles product and wipes product, said method comprising the steps of:
providing at least one absorbent articles product;
providing at least one wipes product; said at least one wipes product having a synergistic effect with said at least one absorbent articles product;
providing a communication for directing a consumer to select a particular combination of said at least one absorbent articles product and said at least one wipes product so as to benefit from said synergistic effect.

2. The method of claim 1 further comprising the steps of acquiring information from the consumer and basing said communication on said information.

3. The method of claim 1 further comprising the step of providing at least one related marketing capability within said communication.

4. The method of claim 3 wherein said related marketing capability is an offering of a coupon.

5. A product line-up for providing at least one intentional, repeatable synergy between at least one absorbent articles product and at least one wipes product, said product line-up capable of directing a consumer to select a particular combination of absorbent articles product and wipes product, said product line-up comprising:
at least one absorbent articles product;
at least one wipes product; said at least one wipes product having a synergistic effect with said at least one absorbent articles product;
a communication for directing a consumer to select a particular combination of said at least one absorbent articles product and said at least one wipes product so as to benefit from said synergistic effect.

6. The product line-up of claim 5 wherein said communication provides information to the consumer such that the consumer may rely on said information in order to select the proper combination of said absorbent articles product and said wipes product for a given need.

7. The product line-up of claim 5 further comprising a user interface, said user interface is capable of presenting at least one question to the consumer, said user interface is capable of using at least one answer to said at least one question in order to make said communication to the consumer as to the proper combination of said absorbent articles product and said wipes product for a given need.

8. The product line-up of claim 5 further comprising at least one related marketing capability within said communication.

9. The product line-up of claim 8 wherein said related marketing capability is an offering of a coupon.

10. The product line-up of claim 5 wherein said at least one absorbent articles product comprises a first absorbent articles product and a second absorbent articles product, said first absorbent articles product having at least one characteristic being different from that of said second absorbent articles product.

11. The product line-up of claim 10 wherein said characteristic may be selected from the group consisting of presence of a perfume, level of a perfume, type of a perfume, absorbency level, size, fit, color, gender-based features, presence of a skin health ingredient, level of a skin health ingredient, type of a skin health ingredient, presence of a film former, level of a film former, type of a film former, presence of a cleaning agent, level of a cleaning agent, type of a cleaning agent.

12. The product line-up of claim 5 wherein said at least one wipes product comprises a first wipes product and a second wipes product, said first wipes product having at least one characteristic being different from that of said second wipes product.

13. The product line-up of claim 12 wherein said characteristic may be selected from the group consisting of presence of a perfume, level of a perfume, type of a perfume, absorbency level, size, fit, color, gender-based features, presence of a skin health ingredient, level of a skin health ingredient, type of a skin health ingredient, presence of a film former, level of a film former, type of a film former, presence of a cleaning agent, level of a cleaning agent, type of a cleaning agent, emulsifiers, emollients, viscosity controlling agents, sequestrants, solubilizers, preservatives, antifoaming agents, antimicrobial agents, antioxidants, reducing agents, oxidizing agents, biological additives, pH adjusters and buffering agents, colorants, cosmetic astringents, cosmetic biocides, film formers, fragrance components, humectants, opacity agents, skin conditioning agents, skin protectants, solvents, sunscreen agents, botanical ingredients, absorbents, astringents, emulsion stabilizers, suspending agents, foam boosters, hydrotropes, and ultraviolet light absorbers.

14. The product line-up of claim 5 wherein said communication of said synergistic effect is based upon the skin type of a wearer.

15. The product line-up of claim 5 wherein said communication of said synergistic effect is based upon the age of a wearer.

16. The product line-up of claim 5 wherein said at least one absorbent articles products comprises of a plurality of absorbent articles products, said plurality absorbent articles products being displayed and sorted by a corresponding grouping within a baby stages of development marketing model.

17. The product line-up of claim 5 wherein said at least one wipes products comprises of a plurality of wipes products, said plurality of wipes products being displayed and sorted by a corresponding grouping within a baby stages of development marketing model.

18. The product line-up of claim 5 wherein said communication is presented in a form selected from the group consisting of posters, pamphlets, coupons, kiosk, personal greeters, internet website, computer system and any other suitable communication devices.

19. The product line-up of claim 5 wherein said communication includes at least one horizontal product recommendation.

20. A product line-up for providing at least one intentional, repeatable synergy between a first baby-related product and a second baby-related product, said product line-up capable of directing a consumer to select a particular combination of first and second baby-related products, said product line-up comprising:
at least one first baby-related product;
at least one second baby-related product; said at least one first baby-related product having a synergistic effect with said at least one second baby-related product;
a communication for directing a consumer to select a particular combination of said at least one first baby-related product and said at least one second baby-related product so as to benefit from said synergistic effect.
